(19) United States
(12) Patent Application Publication
(10) Pub. No.: US 2014/0212737 A1
(43) Pub. Date: Jul. 31, 2014

(54) SPACER FOR BATTERY AND BATTERY PACK INCLUDING THE SAME

(71) Applicant: Samsung SDI Co., Ltd., Yongin-si (KR)

(72) Inventors: Sanghoon Bae, Yongin-si (KR); Youngbin Ko, Yongin-si (KR)

(73) Assignee: Samsung SDI Co., Ltd., Yongin-si (KR)

(21) Appl. No.: 13/953,522

(22) Filed: Jul. 29, 2013

(30) Foreign Application Priority Data
Jan. 28, 2013 (KR) 10-2013-0009416

(51) Int. Cl. H01M 2/10

(52) U.S. Cl. CPC H01M 2/1016; H01M 2/105; H01M 2/1072
USPC 429/176

(57) ABSTRACT

A battery pack includes a spacer. The spacer for the battery pack can be used by being cut according to the number of batteries received in the battery pack, and can thus be applied to multiple battery packs in which different numbers of batteries are received, and can be easily separated manually. In one type of spacer, a first plurality of concave battery receiving parts corresponding to portions of outer surfaces of the cylindrical batteries are formed on a first surface of a rectangular frame, and cutting grooves are formed in the respective battery receiving parts in a direction corresponding to the center axes of the cylindrical batteries to facilitate cutting of the spacer.

### CROSS-REFERENCE TO RELATED APPLICATIONS

This application claims the benefit of Korean Patent Application No. 10-2013-0009416 filed on Jan. 28, 2013, the contents of which are incorporated herein by reference in their entirety.

### BACKGROUND

1. Field

Aspects of the present invention relate to a spacer for a battery pack and a battery pack including the same.

2. Description of the Related Technology

In general, a battery pack that can be applied to a medium- or large-sized electronic device such as a notebook computer, a camcorder, a personal digital assistant (PDA), an automotive vehicle, and the like, includes multiple unit batteries due to capacity limitation of each unit battery.

The battery pack is a battery structure including a plurality of unit batteries electrically connected to each other in series and/or in parallel, and a stable arrangement structure is maintained for sequentially establishing electrical connections between the unit batteries.

Cylindrical secondary batteries used as unit batteries of the battery pack present challenges to maintain the arrangement structure thereof in view of outward appearance. Thus, it is typically necessary to use a separate spacer for fixing the cylindrical secondary batteries.

The battery pack can implement various outputs and capacities by adjusting the number of unit batteries received according to the specifications of electronic devices. However, in multiple battery packs having different numbers of unit batteries received therein, it is necessary to form spacers having various specifications that can be applied to the respective battery packs whenever the battery packs are developed, which is problematic.

### SUMMARY OF CERTAIN INVENTIVE ASPECTS

Embodiments of the present invention have been made in view of the above problems, and aspects of the present invention provide a spacer for a battery pack, which can be used by being cut according to the number of batteries received in the battery pack, so that the spacer can be applied to multiple battery packs in which different numbers of batteries are received.

Aspects of the present invention further provide a spacer for a battery pack, which includes cutting holes for facilitating cutting of the spacer to be easily separated even by a manual work, and a battery pack including the same.

According to aspects of the present invention, there is provided a spacer for a battery pack for arranging or fixing a plurality of cylindrical batteries in a battery pack, the spacer including a rectangular frame; a first plurality of concave battery receiving parts corresponding to portions of outer surfaces of the plurality of cylindrical batteries, wherein the concave receiving parts are formed on a first surface of the rectangular frame; and a cutting groove formed in each of the respective concave battery receiving parts in a direction corresponding to center axes of the plurality of cylindrical batteries.

The cutting grooves may include one or more cutting holes passing through a region between the first surface and a second surface of the rectangular frame.

The cutting grooves may be formed at centers of the respective concave battery receiving parts.

In addition, a second plurality of concave battery receiving parts may be formed on a second surface of the rectangular frame so as to correspond to the first plurality of concave battery receiving parts formed on the first surface of the rectangular frame.

The cutting grooves may be formed at centers of the respective first plurality of concave battery receiving parts and at centers of the respective second plurality of concave battery receiving parts so as to correspond to each other.

The cutting grooves may include one or more cutting holes passing through regions between the centers of the first plurality of concave battery receiving parts and the centers of the second plurality of concave battery receiving parts.

The spacer may further include passing-through holes at intersections of four adjacent concave battery receiving parts between the first and the second surfaces of the rectangular frame in a direction corresponding to an axial direction of the cylindrical batteries.

The intersections may include a total of 12 intersections or a multiple number of 12.

A second plurality of concave battery receiving parts may be formed on a second surface of the rectangular frame such that intersections of the first surface of the rectangular frame at which two adjacent ones of the first plurality of concave battery receiving parts contact each other correspond to the centers of the second plurality of concave battery receiving parts.

Intersections of the second surface of the rectangular frame at which two adjacent ones of the second plurality of concave battery receiving parts contact each other may correspond to the centers of the first plurality of concave battery receiving parts.

The cutting grooves may be formed at locations where thicknesses between the first plurality of concave battery receiving parts and the second plurality of concave battery receiving parts adjacent to the first plurality of concave battery receiving parts.

The cutting grooves may include one or more cutting holes passing through regions between the first plurality of concave battery receiving parts and the second plurality of concave battery receiving parts.

According to aspects of the present invention, there is provided a battery pack including the spacer.

As described above, in the spacer for a battery pack and the battery pack including the spacer, the spacer can be used by being cut according to the number of batteries received in the battery pack, thereby allowing the spacer to be applied to multiple battery packs having different numbers of batteries received herein.

In addition, since cutting holes are provided for facilitating cutting of the spacer, giving divisional spacers, the divisional spacers can be easily separated even by a manual work.

Additional aspects and/or advantages of the invention will be set forth in part in the description which follows and in part will be obvious from the description or may be learned by practice of the invention.

### BRIEF DESCRIPTION OF THE DRAWINGS

The aspects, features and advantages of the present invention will be more apparent from the following detailed description in conjunction with the accompanying drawings, in which:

FIG. 1 is a perspective view of a spacer for a battery pack according to an embodiment of the present invention;

FIGS. 2A and 2B are an enlarged perspective view of the spacer shown in FIG. 1 and a cross-sectional view taken along the line 2b-2b of FIG. 1;

FIG. 3 is a perspective view of a spacer for a battery pack according to another embodiment of the present invention;

FIGS. 4A and 4B are an enlarged perspective view of the spacer shown in FIG. 3 and a cross-sectional view taken along the line 4b-4b of FIG. 3;

FIG. 5 is a perspective view of a spacer for a battery pack according to still another embodiment of the present invention;

FIGS. 6A and 6B are an enlarged plan view of the spacer shown in FIG. 5 and a cross-sectional view taken along the line 6b-6b of FIG. 5;

FIG. 7 is a perspective view illustrating a spacer that is a divisional spacer formed by cutting the spacer shown in FIG. 5, and a cylindrical battery;

FIG. 8 is a perspective view of a spacer for a battery pack according to still another embodiment of the present invention; and

FIG. 9 is a cross-sectional view of the spacer shown in FIG. 8, taken along the line 9b-9b of FIG. 8.

### DETAILED DESCRIPTION OF CERTAIN INVENTIVE EMBODIMENTS

Hereinafter, examples of embodiments of the invention will be described in detail with reference to the accompanying drawings such that they can easily be made and used by those skilled in the art. Reference is made to embodiments, examples of which are illustrated in the accompanying drawings. In the drawings, similar elements are generally denoted by the same reference numerals.

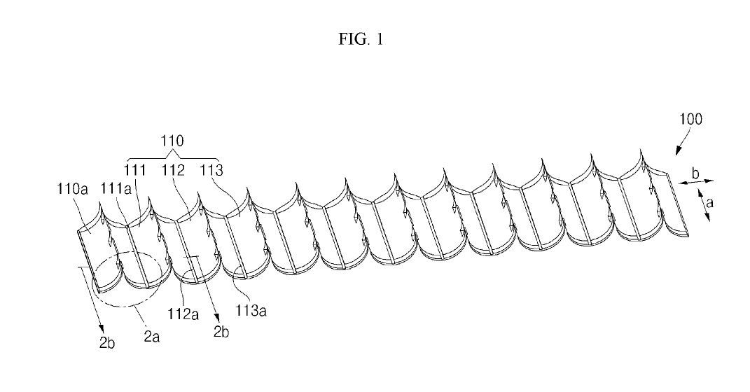

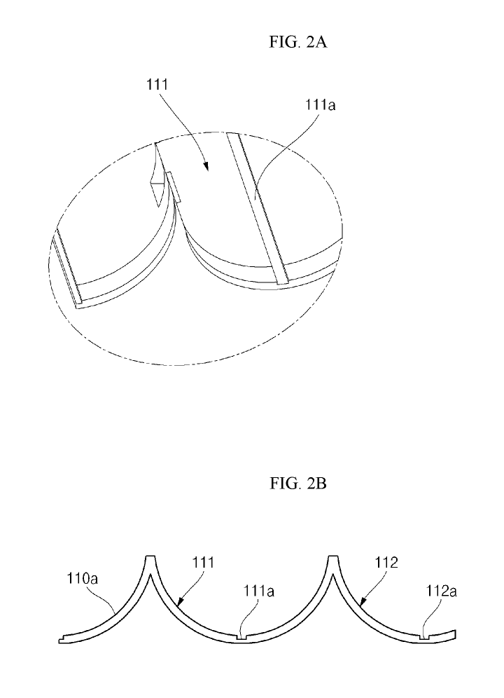

FIG. 1 is a perspective view of a spacer for a battery pack according to an embodiment of the present invention, and FIGS. 2A and 2B are an enlarged perspective view of the spacer shown in FIG. 1 and a cross-sectional view taken along the line 2b-2b of FIG. 1.

As shown in FIGS. 1, 2A and 2B, the spacer 100 for a battery pack is provided for the purpose of arranging or fixing a plurality of cylindrical batteries in the battery pack. The spacer 100 has a rectangular frame, and a plurality of semi-cylindrical battery receiving parts 111,112 and 113 are formed on one surface of the rectangular frame to receive the plurality of cylindrical batteries (not shown). The spacer 100 may allow the plurality of cylindrical secondary batteries to be arranged and fixed in a line such that cylinder parts of the plurality of cylindrical secondary batteries are positioned adjacent to each other.

The respective battery receiving parts 111,112 and 113 are shaped as concave cylinders corresponding to the cylindrical batteries so as to surround parts of cylindrical outer surfaces of the cylindrical batteries. Cylindrical inner surfaces of the battery receiving parts 111,112 and 113 make contact with the parts of the outer surfaces of the cylindrical batteries, thereby arranging or fixing the respective cylindrical batteries in the battery pack.

In addition, cutting grooves 111a, 112a, and 113a are formed in the battery receiving parts 111,112 and 113 in battery axis directions (direction a indicated in FIG. 1) corresponding to the center axes of the cylindrical batteries. The cutting grooves 111a, 112a, and 113a may be formed at centers of the battery receiving parts 111,112 and 113, respectively. The centers of the battery receiving parts 111,112 and 113 may mean the centers as bases for dividing the battery receiving parts 111,112 and 113 to be symmetrical with each other in battery width directions (direction b indicated in FIG. 1) corresponding to arrangement directions of the battery receiving parts 111,112 and 113. Thicknesses of portions of the battery receiving parts 111,112 and 113, where the cutting grooves 111a, 112a, and 113a are formed, may be half or less of thicknesses of the other portions of the battery receiving parts 111,112 and 113.

The spacer 100 having the plurality of battery receiving parts 111, 112 and 113 can be separated into divisional spacers by cutting the centers of the battery receiving parts 111,112 and 113 having the cutting grooves 111a, 112a, and 113a.

The ending battery receiving part 110a positioned at the end of the spacer 100 in the battery width direction (b) is formed as the result of cutting. Therefore, the ending battery receiving part 110a is shaped to surround approximately a quarter (¼) of the cylindrical outer surface of each of a cylindrical battery. The ending battery receiving part 110a is sized to be half of the battery receiving parts 111,112 and 113 as the result of cutting in the battery width direction (b).

Since the spacer 100 can be used by being cut according to the number of batteries received in the battery pack, it can be applied to multiple battery packs having different numbers of batteries received therein, thereby saving the development cost required for forming new molds for developing new battery packs.

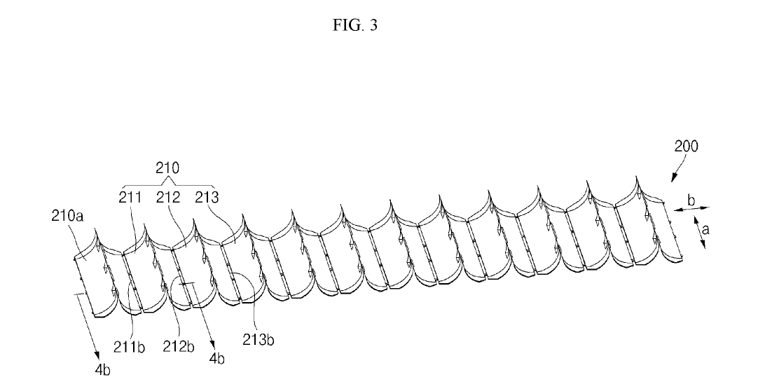

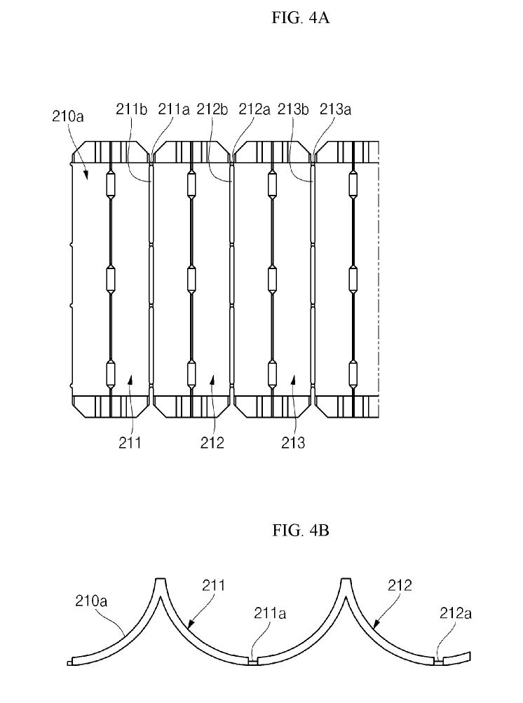

FIG. 3 is a perspective view of a spacer for a battery pack according to another embodiment of the present invention, and FIGS. 4A and 4B are an enlarged perspective view of the spacer shown in FIG. 3 and a cross-sectional view taken along the line 4b-4b of FIG. 3.

As shown in FIGS. 3, 4A and 4B, the spacer 200 for a battery pack is provided for the purpose of arranging or fixing a plurality of cylindrical batteries in the battery pack. The spacer 200 has substantially the same configuration as the spacer 100 shown in FIG. 1, except for configurations of cutting holes. Therefore, the following description will focus on the cutting holes.

One or more cutting holes 211b, 212b, and 213b passing through the spacer 200 in a thickness direction are formed in the cutting grooves 211a, 212a, and 213a. While the number of the cutting holes 211b, 212b, and 213b formed in the respective battery receiving parts 211, 212, and 213 is 3, aspects of the present invention are not limited thereto and fewer or more holes may also be used.

In addition, the spacer 200 including the plurality of battery receiving parts 211, 212, and 213 can be separated into multiple divisional spacers by cutting centers of the battery receiving parts 211, 212, and 213 having the cutting grooves 211a, 212a, and 213a and the cutting holes 211b, 212b, and 213b. The spacer 200 may be cut by a separate device or manually. In addition, in order to facilitate manual cutting of the spacer 200, the cutting holes 211b, 212b, and 213b may be plurally formed lengthwise in the battery axis direction (a). The battery receiving parts 211, 212, and 213 can be easily cut when the cutting holes 211b, 212b, and 213b are formed in relatively wide areas.

Since the spacer 200 can be used by being cut according to the number of batteries received in the battery pack, it can be applied to multiple battery packs in which different numbers of batteries are received. In addition, since the spacer 200 includes cutting holes, it can be easily separated manually.

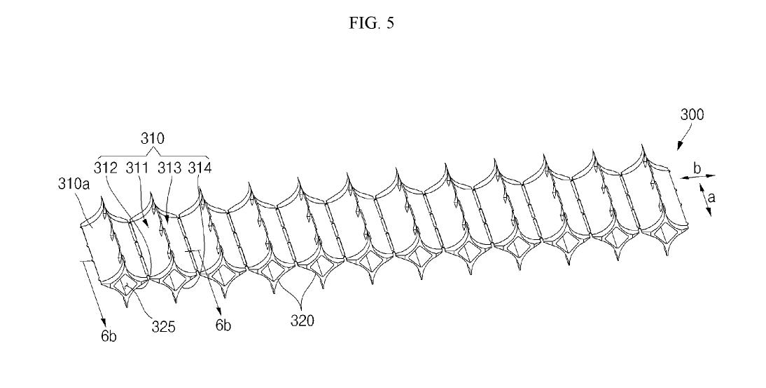

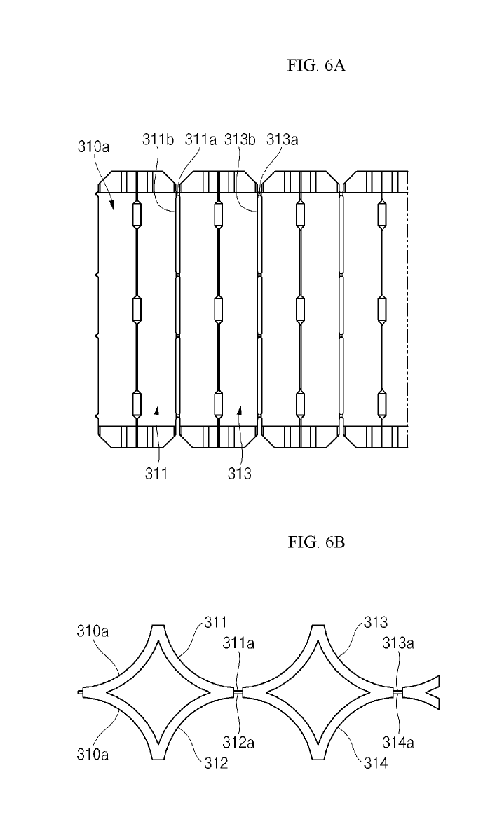

FIG. 5 is a perspective view of a spacer for a battery pack according to still another embodiment of the present invention, and FIGS. 6A and 6B are an enlarged plan view of the spacer shown in FIG. 5 and a cross-sectional view taken along the line 6b-6b of FIG. 5.

As shown in FIGS. 5, 6A and 6B, the spacer 300 for a battery pack is provided for the purpose of arranging or fixing a plurality of cylindrical batteries in the battery pack. The spacer 300 has a rectangular frame, and a plurality of semi-cylindrical battery receiving parts 311 and 313 are formed on a first surface of the rectangular frame to receive the plurality of cylindrical batteries. In addition, the spacer 300 may include a plurality of battery receiving parts 312 and 314 formed on a second surface of the rectangular frame, so as to correspond to the plurality of battery receiving parts 311 and 313 formed on the first surface of the rectangular frame 312 and 314. The spacer 300 may allow the plurality of cylindrical secondary batteries to be arranged and fixed in multiple layers such that cylinder parts of the plurality of cylindrical secondary batteries are positioned adjacent to each other.

The plurality of battery receiving parts 311, 312, 313, and 314 are shaped as concave cylinders corresponding to the cylindrical batteries so as to surround parts of cylindrical outer surfaces of the cylindrical batteries. Cylindrical inner surfaces of the battery receiving parts 311, 312, 313, and 314 make contact with the parts of the outer surfaces of the cylindrical batteries, thereby arranging or fixing the respective cylindrical batteries in the battery pack.

In addition, cutting grooves 311a, 312a, 313a, and 314a are formed in the battery receiving parts 311, 312, 313, and 314 in battery axis direction (a) corresponding to the center axes of the cylindrical batteries. The cutting grooves 311a, 312a, 313a, and 314a may be formed at centers of the battery receiving parts 311, 312, 313, and 314, respectively. The centers of the battery receiving parts 311, 312, 313, and 314 are bases for dividing the battery receiving parts 311, 312, 313, and 314 to be symmetrical with each other in battery width direction (b) corresponding to arrangement directions of the battery receiving parts 311, 312, 313, and 314. Therefore, the cutting grooves 311a and 313a of the battery receiving parts 311 and 313 formed on the first surface of the rectangular frame and the cutting grooves 312a and 314a of the battery receiving parts 311 and 313 formed on the second surface of the rectangular frame are centrally positioned to correspond to each other.

One or more cutting holes 311b and 313b passing through the spacer 300 in a thickness direction are formed in the cutting grooves 311a and 313a.

The cutting holes 311b and 313b pass through regions between the cutting grooves 311a and 313a of the battery receiving parts 311 and 313 formed on the first surface of the rectangular frame and the cutting grooves 312a and 314a of the battery receiving parts 312 and 314 formed on the second surface of the rectangular frame. In addition, the spacer 300 including the plurality of battery receiving parts 311, 312, 313, and 314 can be separated into divisional spacers by cutting the centers of the battery receiving parts 311, 312, 313, and 314 having the cutting grooves 311a, 312a, 313a, and 314a and the cutting holes 311b and 313b.

The spacer 300 may be cut by a separate device or manually. In addition, in order to facilitate manual cutting of the spacer 300, the cutting holes 311b and 313b may be plurally formed lengthwise in the battery axis direction (a). The battery receiving parts 311, 312, 313 and 314 can be easily cut when the cutting holes 311b and 313b are formed in relatively wide areas.

In addition, passing-through holes 325 are further formed at intersections 320 of 4 adjacent battery receiving parts 311, 312, 313, and 314 between the first and the second surfaces of the rectangular frame in a direction corresponding to the battery axis direction (a). The passing-through holes 325 may be provided for the purpose of preventing temperatures of the cylindrical batteries from rising.

The spacer 300 may include 12 intersections 320 or a multiple of 12. In the spacer 300, the number of intersections 320 is limited to fully use the spacer 300 without wasted parts because most of the battery packs receive 6, 8 or 10 cylindrical batteries.

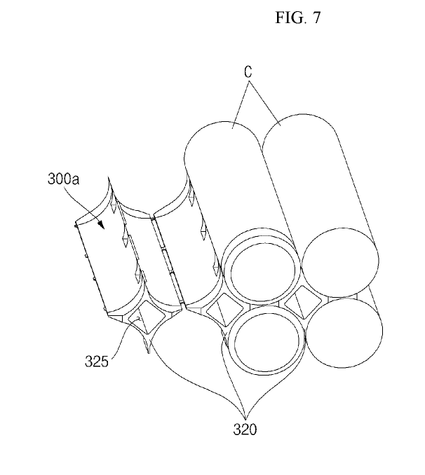

As shown in FIG. 7, for example, the battery pack receiving 8 cylindrical batteries C uses a divisional spacer 300a having three intersections 320. Therefore, a battery pack having 8 cylindrical batteries C received therein may use the spacer 300 having 12 intersections by cutting the same to provide divisional spacers each having three intersections 320. Therefore, the spacer 300 having 12 intersections 320 can be fully used without wasted portions when the number of cylindrical batteries received in the battery pack is 6, 8 or 10.

The ending battery receiving part 310a positioned at the end of the spacer 300 is formed as the result of cutting. Therefore, the ending battery receiving part 310a is shaped to surround approximately a quarter (¼) of the cylindrical outer surface of each of the cylindrical batteries. The ending battery receiving part 310a is sized to be half of the battery receiving parts 311,313 and 315 sized as the result of cutting in the battery width direction (b).

Since the spacer 300 can be used by being cut according to the number of batteries received in the battery pack, it can be applied to multiple battery packs having different numbers of batteries received therein, thereby facilitating manual cutting of the spacer 300 by forming cutting holes 311b and 313b.

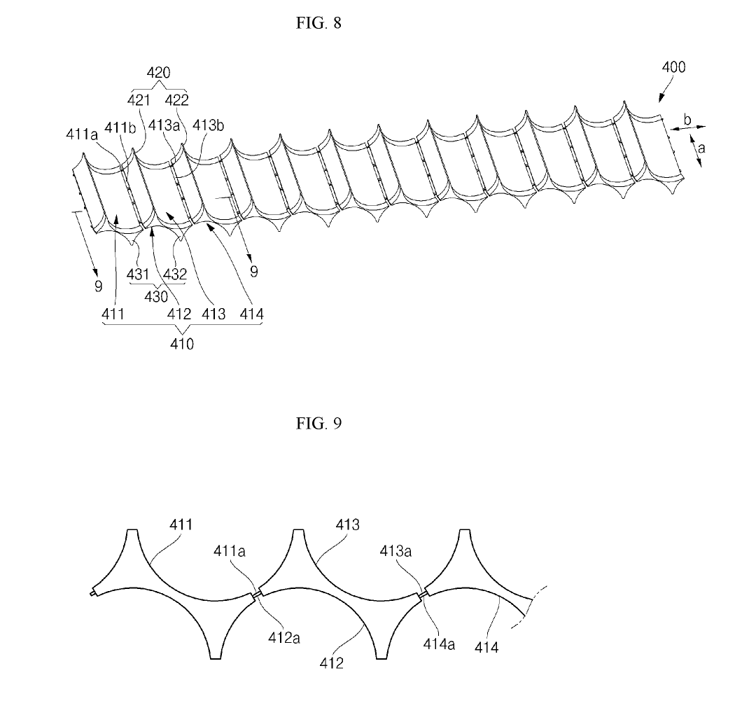

FIG. 8 is a perspective view of a spacer for a battery pack according to still another embodiment of the present invention; and FIG. 9 is a cross-sectional view of the spacer shown in FIG. 8, taken along the line 9b-9b of FIG. 8.

As shown in FIGS. 8 and 9, the spacer 400 for a battery pack is provided for the purpose of arranging or fixing a plurality of cylindrical batteries in the battery pack. The spacer 400 has a rectangular frame, and a plurality of semi-cylindrical battery receiving parts 411 and 413 are formed on a first surface of the rectangular frame to receive the plurality of cylindrical batteries. In addition, first-surface intersections 420 are formed on the first surface of the rectangular frame on which two adjacent battery receiving parts 411 and 413 make contact with each other. A plurality of battery receiving parts 412 and 414 are formed on a second surface of the rectangular frame so as to correspond to the one-surface intersections 420. First-surface intersections 421 and 422 of the rectangular frame may correspond to centers of the battery receiving parts 412 and 414 formed on the second surface of the rectangular frame. The first-surface intersections 421 and 422 of the rectangular frame may be intersections of the two battery receiving parts 411 and 413 formed on the first surface of the rectangular frame and one battery receiving part 412 formed on the second surface of the rectangular frame.

The second-surface intersection 430 where the two adjacent battery receiving parts 412 and 414 make contact with each other is formed on the second surface of the rectangular frame. The second-surface intersections 431 and 432 of the rectangular frame may correspond to centers of the battery receiving parts 411 and 413 formed on the first surface of the rectangular frame. The second-surface intersections 431 and 432 may be intersections of one battery receiving part 413 formed on the first surface of the rectangular frame and the two battery receiving parts 412 and 414 formed on the second surface of the rectangular frame.

The centers of the respective battery receiving parts 411, 412, 413, and 414 may mean the centers as bases for dividing the battery receiving parts 411, 412, 413, and 414 to be symmetrical with each other in battery width direction (b) corresponding to arrangement directions of the battery receiving parts 411, 412, 413, and 414.

The spacer 400 may allow the plurality of cylindrical secondary batteries to be arranged and fixed in multiple layers such that cylinder parts of the plurality of cylindrical secondary batteries are positioned adjacent to each other.

The plurality of battery receiving parts 411, 412, 413, and 414 are shaped as concave cylinders corresponding to cylindrical batteries (not shown) so as to surround parts of cylindrical outer surfaces of the cylindrical batteries. Cylindrical inner surfaces of the battery receiving parts 411, 412, 413, and 414 make contact with the parts of the outer surfaces of the cylindrical batteries, thereby arranging or fixing the respective cylindrical batteries in the battery pack.

In addition, cutting grooves 411a, 412a, 413a, and 414a are formed in the battery receiving parts 411, 412, 413, and 414 in battery axis directions (a) corresponding to the center axes of the cylindrical batteries. The cutting grooves 411a, 412a, 413a, and 414a may be formed at locations where thicknesses between the battery receiving parts 412 and 414 formed on the second surface of the rectangular frame and, the battery receiving parts 411 and 413 formed on the first surface of the rectangular frame adjacent to the battery receiving parts 412 and 414 are smallest.

For example, the first battery receiving part 411 formed on the first surface of the rectangular frame is positioned adjacent to the second battery receiving part 412 formed on the second surface of the rectangular frame. When the circumferential inner surface of the first battery receiving part 411 is divided into three sections, the first cutting groove 411a is formed at a location of 60° between the second section and the third section. In addition, when the circumferential inner surface of the second battery receiving part 412 is divided into three sections, the second cutting groove 412a is formed at a location of 30° between the first section and the second section. In such a manner, the first cutting groove 411a and the second cutting groove 412a are formed at locations corresponding to each other.

One or more cutting holes 411b and 413b passing through the spacer 400 in a thickness direction are formed in the cutting grooves 411a and 413a. The cutting holes 411b and 413b pass through regions between the cutting grooves 411a and 413a of the battery receiving parts 411 and 413 formed on the first surface and the cutting grooves 412a and 414a of the battery receiving parts 412 and 414 formed on the second surface. In addition, the spacer 400 including the plurality of battery receiving parts 411, 412, 413, and 414 can be separated into multiple divisional spacers by cutting centers of the battery receiving parts 411, 412, 413, and 414 having the cutting grooves 411a, 412a, 413a, and 414a and the cutting holes 411b and 413b.

The spacer 400 may be cut by a separate device or manually. In addition, in order to facilitate manual cutting of the spacer 400, the cutting holes 411b and 413b may be plurally formed lengthwise in the battery axis direction (a). The battery receiving parts 411, 412, 413, and 414 can be easily cut when the cutting holes 411b and 413b are formed in relatively wide areas.

Since the spacer 400 can be used by being cut according to the number of batteries received in the battery pack, it can be applied to multiple battery packs in which different numbers of batteries are received. In addition, since the spacer 400 includes cutting holes, it can be easily separated manually.

Although the spacer for a battery pack and the battery pack including the same according to the present invention have been described with reference to certain embodiments thereof, it will be understood by those skilled in the art that a variety of modifications and variations may be made to the present invention without departing from the spirit or scope of the present invention defined in the appended claims, and their equivalents.

What is claimed is:

1. A spacer for a battery pack for arranging or fixing a plurality of cylindrical batteries in a battery pack, the spacer comprising:
a rectangular frame;
a first plurality of concave battery receiving parts corresponding to portions of outer surfaces of the plurality of cylindrical batteries, wherein the concave receiving parts are formed on a first surface of the rectangular frame; and
a cutting groove formed in each of the respective concave battery receiving parts in a direction corresponding to center axes of the plurality of cylindrical batteries.

2. The spacer of claim 1, wherein the cutting grooves include one or more cutting holes passing through a region between the first surface and a second surface of the rectangular frame.

3. The spacer of claim 1, wherein the cutting grooves are formed at centers of the respective concave battery receiving parts.

4. The spacer of claim 1, wherein a second plurality of concave battery receiving parts are formed on a second surface of the rectangular frame so as to correspond to the first plurality of concave battery receiving parts formed on the first surface of the rectangular frame.

5. The spacer of claim 4, wherein the cutting grooves are formed at centers of the respective first plurality of concave battery receiving parts and at centers of the respective second plurality of concave battery receiving parts so as to correspond to each other.

6. The spacer of claim 5, wherein the cutting grooves include one or more cutting holes passing through regions between the centers of the first plurality of concave battery receiving parts and the centers of the second plurality of concave battery receiving parts.

7. The spacer of claim 4, further comprising passing-through holes at intersections of four adjacent concave battery receiving parts between the first and the second surfaces of the rectangular frame in a direction corresponding to an axial direction of the cylindrical batteries.

8. The spacer of claim 7, wherein the intersections include a total of 12 intersections or a multiple number of 12.

9. The spacer of claim 1, wherein a second plurality of concave battery receiving parts are formed on a second surface of the rectangular frame such that intersections of the first surface of the rectangular frame at which two adjacent ones of the first plurality of concave battery receiving parts contact each other correspond to the centers of the second plurality of concave battery receiving parts.

10. The spacer of claim 9, wherein intersections of the second surface of the rectangular frame at which two adjacent ones of the second plurality of concave battery receiving parts contact each other correspond to the centers of the first plurality of concave battery receiving parts.

11. The spacer of claim 9, wherein the cutting grooves are formed at locations where thicknesses between the first plurality of concave battery receiving parts and the second plurality of concave battery receiving parts adjacent to the first plurality of concave battery receiving parts are smallest.

12. The spacer of claim 11, wherein the cutting grooves include one or more cutting holes passing through regions between the first plurality of concave battery receiving parts and the second plurality of concave battery receiving parts.

13. A battery pack including the spacer of claim 1.
